(19) United States
(12) Patent Application Publication
(10) Pub. No.: US 2026/0370761 A1
(43) Pub. Date: Nov. 19, 2026

(54) DYNAMIC ROAMING AUTHENTICATION AND POLICY PROVISIONING

(71) Applicant: T-MOBILE INNOVATIONS LLC, Overland Park, KS (US)

(72) Inventors: James Chungyu LIU, Bellevue, WA (US); Henry HA, Covington, WA (US); Anil Kumar MARIYANI, Ashburn, VA (US)

(21) Appl. No.: 19/209,365

(22) Filed: May 15, 2025

(51) Int. Cl. H04M 15/00; H04W 4/24; H04W 8/04; H04W 8/20; H04W 84/04

(52) U.S. Cl. CPC H04M 15/8038; H04W 4/24; H04W 8/04; H04W 8/20; H04W 84/042

(57) ABSTRACT

Techniques are described for dynamic roaming authorization and policy provisioning in a communications network. A network component receives an attach request associated with a user equipment (UE) via a visited public mobile network (VPMN). During an authorization procedure, the network component initiates a query to a billing query module to retrieve an account type associated with the UE. Based on the retrieved account type, the network component dynamically determines a roaming subscriber identity (RSI) for the UE. An authorization success message including the determined RSI is transmitted toward the VPMN.

### SUMMARY

The present disclosure is directed to dynamic roaming authorization and policy provisioning based on subscriber account attributes, substantially as shown and/or described in connection with at least one of the Figures, and as set forth more completely in the claims.

The present disclosure addresses challenges associated with inefficient roaming authorization and policy assignment in wireless communication networks, particularly in environments where subscriber account types (e.g., consumer, business, government) necessitate differentiated roaming services. In conventional systems, subscriber account information is authenticated deep into the session establishment process, often at the Charging System (CS) layer, after data sessions have already been initiated. This delayed authorization introduces roaming revenue leakage, inefficient resource utilization, and increased network latency.

The present disclosure proposes techniques for dynamically determining a roaming subscriber identity (RSI) based on an account type query performed during the initial attach phase. Upon receiving an attach request from a roaming device, a home subscriber server (HSS) or equivalent component queries the billing system to retrieve the subscriber’s account classification. Based on the retrieved account type, the system dynamically provisions an appropriate RSI that governs the subscriber's data roaming experience (e.g., speed, allowance, or access restrictions). By shifting account type determination and policy assignment to the attach stage, the system reduces revenue leakage, improves authorization efficiency, and enables differentiated roaming experiences across diverse subscriber types and roaming partners. Although examples are primarily described with reference to a single roaming partner and dynamic RSI assignment, the techniques may be extended to support multiple visited public mobile networks (VPMNs) and dynamic business rules across a variety of roaming scenarios. The present disclosure thus helps enable more adaptive, intelligent roaming management and resource allocation.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be illustrative and non-limiting, wherein:

FIG. 1 illustrates a network environment in which implementations of the present disclosure may be employed;

FIG. 2 depicts a call flow in accordance with embodiments described herein;

FIG. 3 depicts a flow diagram of a method for dynamic roaming authorization and policy provisioning in a communications network, in accordance with embodiments described herein; and

FIG. 4 illustrates a computing device for use with the present disclosure;

### DETAILED DESCRIPTION

By way of background, in conventional roaming architectures, attach and authorization procedures between a UE and a home public land mobile network (HPLMN) generally occur through an interaction between a VPMN and the core network associated with the subscriber's home network. Upon initiating an attach request, the UE connects to a base station associated with the VPMN, which in turn forwards the attach request through network signaling nodes such as a mobile management entity (MME) toward the core network of the HPLMN. A network component, such as a home subscriber server (HSS), authenticates the UE and authorizes network access.

However, conventional authorization procedures are typically agnostic to subscriber account types (e.g., whether a subscriber is a consumer, business, or government customer). Subscriber-specific policies, such as differentiated data speeds, priority services, or special contractual roaming terms, are often only applied after the attach procedure completes and after the establishment of a user plane data session. Policy enforcement traditionally relies on post-authentication interactions with charging systems (CS) or billing platforms, wherein a subscriber’s account type is determined and used to apply appropriate policy rules retroactively.

This architecture suffers from several technical drawbacks. Because account type-specific information is not retrieved during the initial attach and authorization phase, subscribers initially enter the roaming network with a generic RSI and uniform service profile. Adjustments based on account type occur only after significant network resources are consumed, and in some cases, unbilled data usage may occur during the latency between attach acceptance and full policy enforcement. Furthermore, routing account type verification through downstream systems such as the charging system increases signaling traffic, impacts key performance indicators (KPIs), and contributes to unnecessary load on critical network nodes. The inability to distinguish and differentiate subscriber policies during initial attach not only reduces operational efficiency, but also causes financial inefficiencies.

The present disclosure addresses these and other shortcomings by introducing systems and methods that dynamically provision roaming subscriber identities based on subscriber account type during the initial attach and authorization procedure itself. In particular, a billing query module is communicatively coupled to the HSS, the billing system, or equivalent network components. During authorization, the network component may initiate a real-time query to the billing query module, which interacts with a billing system to retrieve the subscriber’s account type. Based on the retrieved account type, the network component dynamically determines and assigns an appropriate RSI prior to completing the attach procedure and prior to establishment of a user plane data session. The assigned RSI dictates the UE’s data roaming policy, enabling immediate enforcement of differentiated service profiles such as throttled speeds, prioritized access, restricted services, or blocked roaming for certain account types or roaming partner profiles.

By dynamically incorporating account type information into the initial attach and authorization flow, the disclosed systems and methods substantially reduce roaming revenue leakage, enhance network efficiency, and improve the ability to align service provisioning with business agreements or service-level objectives. Moreover, by introducing a billing query module as part of the real-time authorization flow, the system enables flexible roaming policy enforcement across multiple visited networks without requiring session teardown, re-attachment, or post-establishment policy corrections. The techniques described herein are applicable across a variety of mobile communication environments, including but not limited to 4G LTE networks, 5G NR networks, and future-generation mobile systems (e.g., 6G) supporting roaming functionality.

Accordingly, a first aspect of the present disclosure is directed to a system for dynamic roaming authorization and policy provisioning in a communications network. The system may comprise a network component comprising one or more processors, a billing query module, and a non-transitory computer-readable media comprising executable instructions. When executed by the one or more processors, the executable instructions may cause the network component to perform operations comprising receiving, from a visited public mobile network (VPMN), an attach request associated with a user equipment (UE); during an authorization procedure associated with the attach request, initiating, via the billing query module, a query to a billing system to retrieve an account type associated with the UE; receiving, from the billing system, a response indicating the account type associated with the UE; determining, based at least in part on the retrieved account type, a roaming subscriber identity (RSI) for the UE; and transmitting, toward the VPMN, an authorization success message that includes the determined RSI.

In another aspect, the present disclosure is directed to a non-transitory computer-readable media having computer-executable instructions stored thereon that, when executed by one or more computer processor components, cause the one or more computer processor components to perform operations for dynamic roaming authorization and policy provisioning in a communications network. The operations may comprise receiving, from a visited public mobile network (VPMN), an attach request associated with a user equipment (UE); during an authorization procedure associated with the attach request, initiating, via a billing query module, a query to a billing system to retrieve an account type associated with the UE; receiving, from the billing system, a response indicating the account type associated with the UE; determining, based at least in part on the retrieved account type, a roaming subscriber identity (RSI) for the UE; and transmitting, toward the VPMN, an authorization success message that includes the determined RSI.

In yet another aspect, the present disclosure is directed to a method for dynamic roaming authorization and policy provisioning in a communications network. The method may comprise receiving, from a visited public mobile network (VPMN), an attach request associated with a user equipment (UE); during an authorization procedure associated with the attach request, initiating, via a billing query module, a query to a billing system to retrieve an account type associated with the UE; receiving, from the billing system, a response indicating the account type associated with the UE; determining, based at least in part on the retrieved account type, a roaming subscriber identity (RSI) for the UE; and transmitting, toward the VPMN, an authorization success message that includes the determined RSI.

In some aspects of the present disclosure, the network component described herein may be implemented as a HSS associated with the communications network. The HSS may be configured to manage authentication, authorization, and subscriber information retrieval functions during attach procedures, and may interact with the billing query module to perform account type determinations during authorization.

In certain aspects, the billing query module may be communicatively coupled with the billing system within the communications network. The billing query module may facilitate real-time access to subscriber account type information during authorization operations, such that a query from the network component during the attach procedure can be dynamically fulfilled based on up-to-date subscriber data.

In additional aspects, the account type retrieved from the billing system may indicate one of a consumer account, a business account, or a government account. In such implementations, the determined RSI may be selected from among a plurality of predefined RSIs based at least in part on the account type associated with the UE. Each RSI may correspond to a specific data roaming policy configured for the identified account type, such as throttled data speeds for consumer accounts or prioritized roaming access for government accounts.

In further aspects, the query to the billing system and the determination of the RSI may be performed before establishing a user plane data session for the UE. That is, the retrieval of account type information, assignment of the RSI, and transmission of an authorization success message including the RSI may be completed during the initial attach and authorization procedure itself, prior to any establishment of an active data session or charging session associated with the UE.

In yet other aspects, the authorization success message transmitted toward the VPMN may include an indication of the determined RSI embedded within an authorization accept procedure. For example, the authorization accept procedure may be extended or modified to incorporate parameters reflecting the selected RSI, such that the serving network elements within the VPMN may immediately configure the UE’s roaming session according to the appropriate data policy without requiring additional signaling exchanges.

In some examples, the attach procedure may be completed based at least in part on the determined RSI prior to initiating a charging session for the UE. In these examples, the charging system may be invoked only after the RSI has been dynamically assigned and appropriate roaming policies have been enforced, thereby reducing unnecessary signaling overhead on the charging infrastructure and mitigating revenue leakage associated with delayed policy application.

In still further aspects, the network component may be configured to dynamically modify the RSI associated with the UE in response to roaming across different VPMNs. For example, upon detecting a change in the visited network or PLMN identifier associated with the UE, the network component may reinitiate a billing system query and, based on updated account type or roaming partner information, assign a new RSI corresponding to the updated roaming environment.

In additional implementations, the billing query module may be configured to select between different RSIs based on a policy framework comprising roaming partner agreements. The policy framework may define various roaming behaviors, preferences, or restrictions depending on the business terms established between the home network operator and one or more visited network operators. Based on such policy frameworks, the billing query module and network component may jointly determine the optimal RSI to assign to the UE during authorization.

In certain examples, if a query to the billing system fails or if account type information cannot be retrieved within a predefined threshold period, the system may be configured to determine a default RSI for the UE. The default RSI may correspond to a generic roaming policy applicable to unidentified or unclassified subscribers, thereby ensuring uninterrupted service while mitigating risk associated with misclassification.

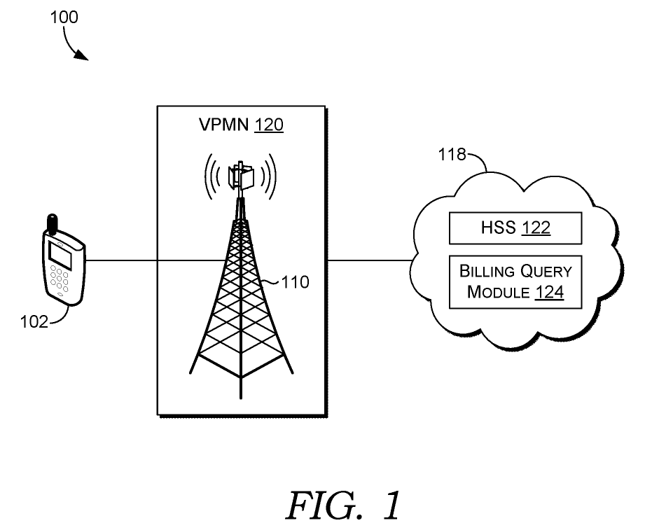

Turning now to FIG. 1, a network environment 100 is depicted, within which implementations of the present disclosure may be utilized. The network environment 100 comprises one or more of a UE 102, a base station 110, a core network 118, a VPMN 120, an HSS 122, and a billing query module 124. The network environment 100 is illustrated as including singular instances of various components for clarity; however, multiple instances of each component are anticipated. For example, the network environment 100 may include multiple gateways, multiple satellites with or without inter-satellite links (ISLs), multiple terrestrial base stations, multiple UEs, and multiple distinct networks, any of which may be interconnected, federated, virtualized, or otherwise structured to provide seamless connectivity, mobility, and service continuity.

Though illustrated as a mobile phone, the UE 102 may be any communication-capable device having one or more features, components, or characteristics of the computing device 600 of FIG. 6. In non-limiting examples, the UE 102 may be a tablet, laptop, desktop computer, connected consumer electronic device (e.g., smart TV), embedded module, IoT sensor, vehicle, aerial drone, smart wearable, industrial machine, or computing node in an edge computing framework. The UE 102 may support one or more wireless communication protocols, including 3GPP-based cellular access technologies (e.g., LTE, NR, 6G), unlicensed spectrum protocols (e.g., 802.11 Wi-Fi, Bluetooth, UWB, Zigbee, LoRaWAN), and/or satellite-specific protocols (e.g., DVB-S2, DVB-RCS2, CCSDS, proprietary waveforms). The UE 102 may be configured to operate in various mobility scenarios, including stationary, pedestrian, vehicular, airborne, or maritime mobility profiles, and may support adaptive transmission parameters such as beamforming, dynamic frequency selection, carrier aggregation, dual connectivity, multi-RAT coordination, and heterogeneous network (HetNet) offloading.

The network 118 may comprise one or more interconnected networks and may include, individually or in combination, a cellular core network, an IP Multimedia Subsystem (IMS) network, or other packet-switched data networks, such as the Internet, enterprise networks, cloud infrastructures, content delivery networks (CDNs), broadband access networks operated by non-cellular Internet Service Providers (ISPs), or satellite core networks. In aspects wherein the network 118 takes the form of a cellular core network (e.g., a 4G LTE Evolved Packet Core (EPC), a 5G Core (5GC), or a future 6G core network), the network 118 may comprise one or more network functions, including but not limited to an Access and Mobility Management Function (AMF), Session Management Function (SMF), Short Message Service Function (SCSF), User Plane Function (UPF), Policy Control Function (PCF), Network Exposure Function (NEF), Unified Data Management (UDM), Unified Data Repository (UDR), Authentication Server Function (AUSF), Network Repository Function (NRF), Policy Control and Charging Function (PCF), Service Communication Proxy Function (SCPF), Session Management Function (SMF), Security Edge Protection Proxy (SEPP), Network Slice Selection Function (NSSF), Service Capability Exposure Function (SCEF), and one or more gateways (e.g., Packet Data Network Gateway (P-GW), Serving Gateway (SGW), User Plane Gateways, or similar nodes). The network 118 may facilitate capabilities such as mobility management, protocol translation, traffic tunneling, session management, network exposure, security enforcement, authentication, authorization, accounting, policy management, charging, and network slicing. Additionally, the network 118 may interconnect with multiple radio access networks (RANs), each associated with a unique or shared Public Land Mobile Network (PLMN) ID, Mobile Country Code (MCC), Mobile Network Code (MNC), or other identifiers relevant to cellular, satellite, private, hybrid, or non-cellular contexts.

The base station 110 may comprise any suitable access node configured to facilitate wireless communications between user equipment and a network. For example, the base station 110 may include, but is not limited to, a NodeB, an evolved NodeB (eNB), a next generation NodeB (gNB), a base transceiver station (BTS), a wireless access point, or another suitable network access component. The base station 110 may include hardware and software components for supporting wireless communication protocols, such as protocols defined in one or more of the 3GPP standards, IEEE 802.11 standards, or other wireless communication standards. The base station 110 may include one or more antennas, radio frequency (RF) transceivers, baseband processing units, control logic, memory components, and network interface modules. In some implementations, the base station 110 may be configured to provide control plane and/or user plane connectivity to user equipment, facilitate mobility management procedures, and support handover operations. Although a single base station 110 is illustrated in FIG. 1, it should be understood that a communications network environment may include any number of base stations 110, which may be geographically distributed and communicatively coupled to other network components.

The visited public mobile network (VPMN) 120 may comprise any suitable network operated by an entity different from the home network operator associated with the UE 102. The VPMN 120 may provide wireless communication services to roaming subscribers and may include various network nodes and interfaces for facilitating access to home network services. In some implementations, the VPMN 120 may include radio access network (RAN) components, core network elements, signaling gateways, and other infrastructure configured to support roaming connectivity. The VPMN 120 may include components compliant with one or more communication standards, such as Universal Mobile Telecommunications System (UMTS), Long Term Evolution (LTE), 5G New Radio (NR), or other mobile network standards. The VPMN 120 may be configured to forward attach requests and authorization signaling received from roaming user equipment to a core network associated with a home public land mobile network (HPLMN). Although a single VPMN 120 is illustrated in FIG. 1, it should be understood that a user equipment may roam across multiple visited networks, and that a communications network environment may include any number of VPMNs 120.

The home subscriber server (HSS) 122 may comprise any suitable network component configured to store and manage subscriber information and support authentication, authorization, and mobility management functions for user equipment. The HSS 122 may include one or more processors, memory components, and network interfaces, and may operate according to communication protocols compliant with one or more standards such as the 3GPP Evolved Packet Core (EPC) architecture, 5G core network architecture, or other suitable frameworks. The HSS 122 may be configured to maintain subscriber profile information, subscription data, authorization credentials, quality of service parameters, mobility state information, and other attributes associated with a user equipment. In some examples, the HSS 122 may facilitate authorization procedures during an attach process by validating subscriber credentials and determining appropriate roaming policies. Although a single HSS 122 is illustrated in FIG. 1, it should be understood that the functionality attributed to the HSS 122 may be distributed across multiple network nodes, databases, or virtualized network functions within a communications network environment.

The billing query module 124 may comprise any suitable hardware component, software component, or combination thereof, configured to facilitate dynamic retrieval of subscriber account information from a billing system during an authorization procedure. In some implementations, the billing query module 124 may include one or more processors, memory components, communication interfaces, and control logic configured to interact with network databases, billing platforms, or subscriber management systems. The billing query module 124 may be integrated within the core network 118, co-located with the HSS 122, or implemented as a standalone network function communicatively coupled to other core network elements.

The billing query module 124 may be configured to receive real-time queries initiated by the HSS 122 or other network components during the authorization phase of an attach procedure. In response to receiving a query associated with a UE, the billing query module 124 may retrieve subscriber-specific information from one or more billing systems, including, but not limited to, an account type associated with the UE. In various examples, the billing query module 124 may interact with billing systems configured to maintain customer account records, service level agreements, payment histories, subscription categories, or contractual roaming terms.

In certain implementations, the billing query module 124 may be configured to process queries and responses with minimal latency to avoid delaying attach procedures. The billing query module 124 may implement optimized data access techniques, query prioritization strategies, caching mechanisms, or other enhancements to facilitate efficient retrieval of account type information. The billing query module 124 may also be configured to format or translate responses from backend billing databases into formats consumable by the HSS 122 or other authorization components.

In some examples, the billing query module 124 may be configured to access multiple billing systems or distributed data stores and may apply selection logic based on identifiers such as a HPLMN identifier, subscriber identity, or service plan type. In further examples, the billing query module 124 may be configured to implement fallback procedures, such as assigning a default account type or default roaming profile, in the event that a billing query cannot be completed within a predefined time period or if a billing system becomes temporarily unavailable.

The billing query module 124 may help enable real-time integration of account type information into the attach authorization process, thereby allowing the HSS 122 to dynamically determine an appropriate RSI for the UE prior to completing the attach procedure. By introducing the billing query module 124 into the authorization signaling flow, the communications network environment 100 is able to differentiate roaming policies based on account type at an earlier phase, improve network efficiency, reduce roaming revenue leakage, and enforce dynamic roaming service profiles across different subscriber categories and roaming partners.

Although a single billing query module 124 is illustrated in FIG. 1, it should be understood that the functionality attributed to the billing query module 124 may be distributed across multiple network components, virtualized network functions (VNFs), or cloud-native network functions (CNFs), and may be scaled dynamically based on network demand, billing system architecture, or service deployment strategies.

Referring again to FIG. 1, the components of communications network environment 100 may cooperate to dynamically provision a RSI for the UE 102 based at least in part on an account type associated with the UE 102. In operation, the UE 102 may initiate an attach procedure by transmitting an attach request to the base station 110. The base station 110, operating within the VPMN 120, may receive the attach request and forward associated signaling messages through the VPMN 120 infrastructure toward the core network 118 of the HPLMN.

Upon receiving the attach request via signaling from the VPMN 120, the core network 118, and in particular the HSS 122, may initiate authorization procedures for the UE 102. During the authorization process, and in contrast to conventional roaming architectures, the HSS 122 may initiate or coordinate a real-time query to the billing query module 124. The query may request subscriber-specific information, such as the account type associated with the UE 102, which is not typically included in standard roaming authorization payloads.

The billing query module 124 may receive the query from the HSS 122 or another component and may communicate with one or more billing systems or subscriber databases to retrieve the requested account type information. In some examples, the billing query module 124 may perform database lookups, apply policy rules, or aggregate data across multiple backend sources to determine the appropriate account classification for the UE 102. The billing query module 124 may then transmit a response to the HSS 122, providing the account type information retrieved from the billing infrastructure.

In some implementations, the billing query module 124 may initiate a query to a billing system during an authorization procedure by using information included within an attach request or associated authorization signaling transmitted by the UE 102. For example, the billing query module 124 or the HSS 122 may extract subscriber identification information from the attach request, such as an International Mobile Subscriber Identity (IMSI), a Mobile Station International Subscriber Directory Number (MSISDN), a Globally Unique Temporary Identifier (GUTI), or another unique identifier associated with the UE 102. The extracted subscriber information may serve as a query key or lookup index used to access corresponding account records maintained by one or more billing platforms or subscriber databases.

The querying process may involve the billing query module 124 transmitting a structured query message to a backend billing system, formatted according to a predefined communication protocol, database access protocol, or application programming interface (API) specification. In some examples, the query message may include additional metadata extracted from the authorization request, such as a home network identifier (e.g., home public land mobile network (HPLMN) ID), subscription plan identifiers, or roaming network identifiers (e.g., visited PLMN (VPLMN) ID), to facilitate more granular or context-sensitive account lookups.

Upon receipt of the query, the billing system may perform a lookup operation against one or more subscriber databases to retrieve account attributes associated with the identified UE 102. In particular, the billing system may retrieve an account type classification, which may specify whether the subscriber account is categorized as a consumer account, a business account, a government account, or another account type. In additional examples, the billing system may return further information, such as roaming entitlements, service-level agreements, special roaming restrictions, or preferred policy templates applicable to the subscriber.

The billing system may format the retrieved information into a query response message and transmit the response back to the billing query module 124. The billing query module 124 may receive the query response and may perform additional processing, such as translating data fields into formats consumable by the HSS 122, filtering or validating response contents, or applying policy mapping rules to associate retrieved account types with corresponding roaming subscriber identities (RSIs). Following receipt and processing of the query response, the billing query module 124 may provide the relevant account type information to the HSS 122.

Based at least in part on the retrieved account type, the HSS 122 may dynamically determine a RSI to assign to the UE 102. The RSI may correspond to a specific roaming policy configured for the account type, such as a differentiated data speed, service access profile, or roaming allowance. The HSS 122 may embed an indication of the determined RSI within an authorization success message or associated signaling response, which is transmitted back through the VPMN 120 toward the base station 110.

The base station 110, upon receiving the authorization success message, may complete the attach procedure with the UE 102. In doing so, the VPMN 120 and base station 110 may provision the UE 102 with the appropriate roaming profile, policies, or restrictions associated with the assigned RSI, thereby ensuring that differentiated service treatment is applied immediately upon session establishment. By dynamically provisioning RSI assignments during an initial attach and authorization phase, the communications network environment 100 reduces roaming revenue leakage, minimizes latency associated with post-attach policy corrections, improves the efficiency of authorization KPIs, and enables fine-grained control over roaming service behaviors based on subscriber account classifications.

In some implementations, the billing query module 124 may also support additional functionality, such as dynamically selecting between multiple RSIs based on roaming partner agreements, caching frequently accessed account information to improve query responsiveness, or implementing fallback behaviors by assigning default RSIs when billing system queries fail. Similarly, the HSS 122 may be configured to monitor mobility events or changes in visited networks and, based on such events, reinitiate billing queries and reassign RSIs dynamically during an active roaming session if necessary.

While FIG. 1 illustrates a single UE 102, a single base station 110, a single VPMN 120, and a single core network 118 for ease of explanation, it should be understood that a communications network environment may include any number of user equipment, base stations, visited networks, home networks, and associated core network components. Moreover, the functionality of the illustrated components may be distributed across multiple physical or virtualized entities, and any given network entity may perform additional functions not specifically described herein.

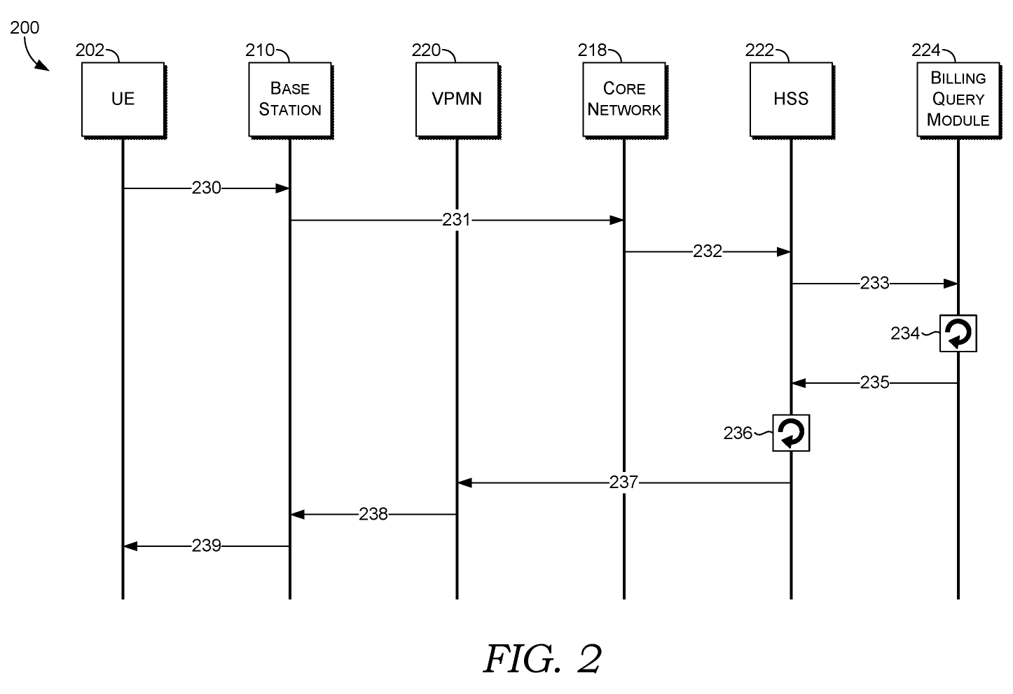

FIG. 2 illustrates an example call flow diagram 200 for dynamic roaming authorization and policy provisioning based on subscriber account type, according to one or more aspects of the present disclosure. The call flow diagram 200 involves interactions between a user UE 202, a base station 210 operating within a VPMN 220, and a core network 218 associated with a HPLMN. Within the core network 218, a HSS 222 and a billing query module 224 cooperate to dynamically determine and provision an RSI for the UE 202 during an initial attach and authorization procedure based at least in part on account type information associated with the UE 202.

At step 230, the UE 202 transmits an attach request to the base station 210. The attach request may comprise one or more signaling messages formatted according to a wireless communication standard, such as a Non-Access Stratum (NAS) attach request in a Long Term Evolution (LTE) network or a Registration Request in a 5G New Radio (NR) network. The attach request may include subscriber identification information associated with the UE 202, such as an International Mobile Subscriber Identity (IMSI), a Mobile Station International Subscriber Directory Number (MSISDN), a Globally Unique Temporary Identifier (GUTI), or a Subscription Permanent Identifier (SUPI). In some examples, the attach request may further include additional information such as a mobile country code (MCC), a mobile network code (MNC), an access point name (APN) identifying a requested packet data network, service request indicators specifying desired service types (e.g., voice, data, emergency services), roaming restriction flags, UE radio capability information, or network slice selection information. The information included in the attach request may be used by the network component to authenticate the UE 202 and may also serve as input for a billing system query during the authorization procedure.

At step 231, the base station 210 forwards the attach request through the VPMN 220 infrastructure toward the core network 218. At step 232, the HSS 222 within the core network 218 receives the attach request associated with the UE 202. Upon receipt, the HSS 222 initiates authorization procedures to validate the credentials and subscription status of the UE 202. Unlike conventional systems, the HSS 222 dynamically initiates additional operations during the authorization process to retrieve account type information.

At step 233, during the authorization procedure associated with the attach request, the HSS 222 initiates a query to the billing query module 224. The query may include information extracted from the attach request, such as the IMSI, MSISDN, GUTI, SUPI, MCC, MNC, APN, service request indicators, roaming flags, or other identifiers associated with the UE 202. In some implementations, the query may also include contextual information such as the identity of the VPMN 220 or service parameters requested by the UE 202. The extracted information may enable the billing query module 224 to perform a more targeted lookup operation against one or more billing systems, allowing for more accurate determination of an account type classification associated with the UE 202.

At step 234, the billing query module 224 receives the query from the HSS 222 and performs a lookup operation against one or more billing systems or subscriber management databases to retrieve account attributes associated with the UE 202. In some examples, the billing query module 224 may access a billing database keyed by the IMSI, SUPI, MSISDN, or other subscriber identifier provided in the query. The billing system may maintain records for each subscriber indicating account classifications, such as consumer, business, government, enterprise, or other account types. The billing query module 224 may retrieve the account type directly from a subscriber profile record or may derive the account type by evaluating associated attributes, such as the subscriber’s service plan identifier, billing group assignment, customer profile tier, or roaming entitlement flags. In certain implementations, the billing query module 224 may aggregate information across multiple backend sources, apply policy mapping rules, or resolve conflicting account attributes to determine a definitive account type classification associated with the UE 202.

At step 235, the billing query module 224 transmits a response message back to the HSS 222. The response message may include an explicit account type classification for the UE 202, such as an indication that the subscriber account is a consumer, business, or government account. In some examples, the response message may further include auxiliary data associated with the subscriber account, such as roaming privileges, data usage entitlements, preferred policy templates, service tier identifiers, or special contractual restrictions applicable to roaming scenarios. The information provided in the response message may enable the HSS 222 to make a dynamic, context-aware determination of an RSI that aligns with the subscriber’s service entitlements and business rules applicable to roaming partnerships.

At step 236, the HSS 222 receives the response from the billing query module 224 and determines an RSI for the UE 202 based at least in part on the retrieved account type. In some implementations, the HSS 222 may map the account type classification to a corresponding RSI using a predefined policy mapping table or dynamic rule set. For example, an account classified as a business account may be assigned an RSI associated with unrestricted high-speed roaming privileges, while an account classified as a consumer account may be assigned an RSI associated with throttled data access or restricted roaming services. In additional examples, the HSS 222 may apply more granular logic, selecting among multiple RSIs based on a combination of account type, roaming partner characteristics, service-level agreements, or other contextual factors. The determined RSI is then prepared for inclusion in the authorization success message transmitted to the VPMN 220 to complete the attach procedure for the UE 202.

At step 237, the HSS 222 generates and transmits an authorization success message toward the VPMN 220, including an indication of the determined RSI. The authorization success message may be formatted according to network standards and may embed the RSI as part of an authorization accept procedure or associated signaling parameter.

At step 238, the VPMN 220 forwards the authorization success message to the base station 210. The forwarded signaling enables the base station 210 to complete the attach procedure with the UE 202 in accordance with the determined RSI and the associated roaming policy.

At step 239, the base station 210 completes the attach procedure with the UE 202. Based at least in part on the assigned RSI, the UE 202 is provisioned with a differentiated roaming profile that governs data session parameters, quality of service settings, service access entitlements, or other aspects of the UE’s roaming experience.

Although the call flow diagram 200 illustrates a particular sequence of interactions between specific components, it should be understood that variations may exist. For example, additional intermediate signaling steps, confirmations, error handling procedures, or security verifications may occur without departing from the principles disclosed herein. Moreover, the operations performed by the core network 218 may be distributed across multiple virtualized or physical network components depending on network implementation and deployment scenarios.

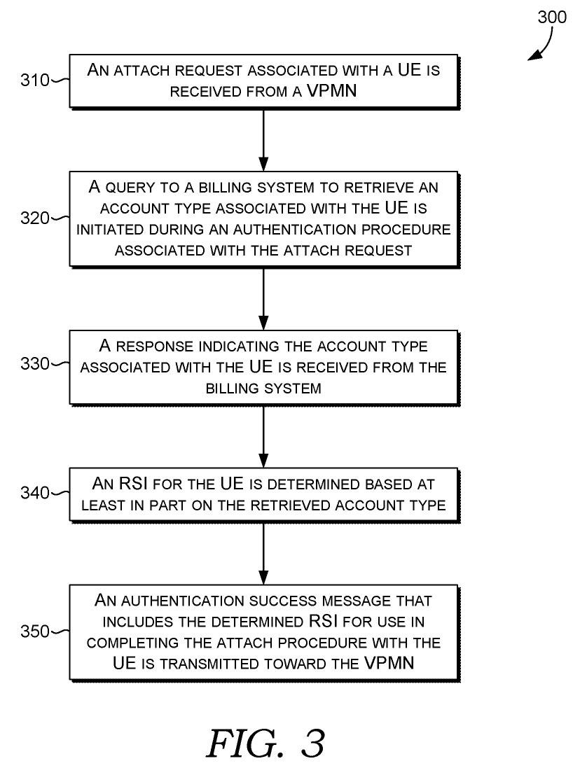

Turning now to FIG. 3, a flow chart is provided to illustrate a method 300 for use with the present disclosure. The method 300 is generally directed to dynamic roaming authorization and policy provisioning in a communications network. At a first step 310, an attach request associated with a UE is received from a VPMN, according to any one or more aspects described with respect to FIGS. 1-2. At a second step 320, a query to a billing system to retrieve an account type associated with the UE is initiated during an authorization procedure associated with the attach request, according to any one or more aspects described with respect to FIGS. 1-2. At a third step 330, a response indicating the account type associated with the UE is received from the billing system, according to any one or more aspects described with respect to FIGS. 1-2. At a fourth step 340, an RSI for the UE is determined based at least in part on the retrieved account type, according to any one or more aspects described with respect to FIGS. 1-2. At a fifth step 350, an authorization success message that includes the determined RSI for use in completing the attach procedure with the UE is transmitted toward the VPMN, according to any one or more aspects described with respect to FIGS. 1-2.

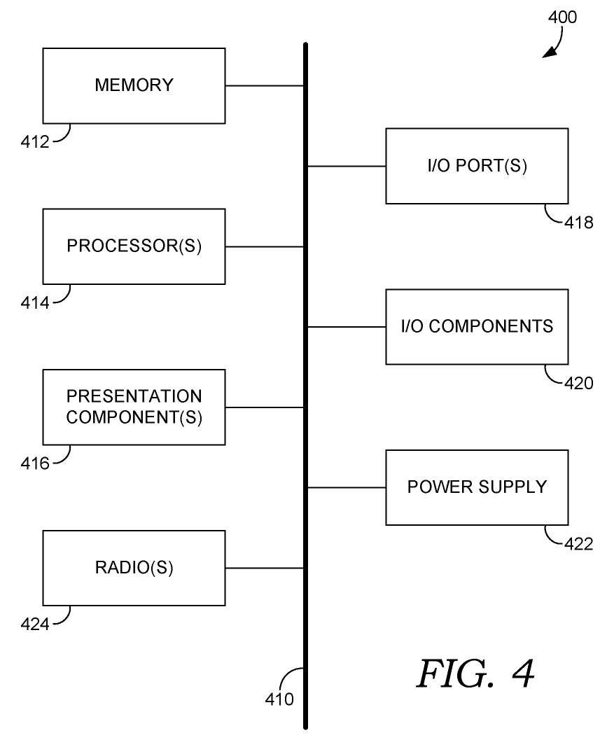

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

The subject matter of embodiments of the invention is described with specificity herein to meet statutory requirements. However, the description itself is not intended to limit the scope of this patent. Rather, the inventors have contemplated that the claimed subject matter might be embodied in other ways, including through different steps or combinations of steps similar to those described in this document, in conjunction with other present or future technologies. Moreover, although the terms “step” and/or “block” may be used herein to connote different elements of methods employed, such terms should not be interpreted as implying any particular order among or between various steps herein disclosed unless and except when the order of individual steps is explicitly described.

Various technical terms, acronyms, and shorthand notations are employed to describe, refer to, and aid the understanding of certain concepts pertaining to the present disclosure. Unless otherwise noted, such terms should be understood in the manner they would be interpreted by one of ordinary skill in the telecommunications arts. An illustrative resource that defines many of these terms is Newton’s Telecom Dictionary (e.g., 32nd Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology” (NAT) is synonymous with wireless communication protocol and is an umbrella term used to refer to the technological standard or protocol that governs communication between a UE and a base station. Examples of suitable network access technologies include, but are not limited to, 3GPP-based systems (e.g., 3G, 4G LTE, 5G NR, 6G), IEEE 802.11x standards, and other wireless communication protocols.

Embodiments of the technology described herein may be embodied as, among other things, a method, system, or computer-program product. Accordingly, the embodiments may take the form of a hardware embodiment, a software embodiment, or an embodiment combining software and hardware. In some embodiments, the technology may take the form of a computer-program product that includes computer-useable instructions embodied on one or more computer-readable media that, when executed, cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media include computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data on a momentary, temporary, or permanent basis.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative implementations of the foregoing can be realized without departing from the scope of the claims below. Certain features and subcombinations may be useful independently and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

Certain embodiments of the present disclosure may interoperate with or extend features defined in standardized wireless communication protocols, including those published by 3GPP or IEEE. References to specific features or capabilities in these standards are intended to facilitate understanding and are not intended to limit the scope of the claimed invention to any particular implementation or release version thereof.

What is claimed is:

1. A system for dynamic roaming authorization and policy provisioning in a communications network, the system comprising:
a network component comprising one or more processors;a billing query module; anda non-transitory computer-readable media comprising executable instructions that, when executed, causes the network component to perform operations in the communications network, comprising:receiving, from a visited public mobile network (VPMN), an attach request associated with a user equipment (UE);during an authorization procedure associated with the attach request, initiating, via the billing query module, a query to a billing system to retrieve an account type associated with the UE;receiving, from the billing system, a response indicating the account type associated with the UE;
determining, based at least in part on the retrieved account type, a roaming subscriber identity (RSI) for the UE; and
transmitting, toward the VPMN, an authorization success message that includes the determined RSI.

2. The system of claim 1, wherein the network component is a Home Subscriber Service (HSS) associated with the communications network.

3. The system of claim 1, wherein the billing query module is communicatively coupled with the billing system within the communications network.

4. The system of claim 1, wherein the account type indicates one of a consumer account, a business account, or a government account.

5. The system of claim 4, wherein determining the RSI comprises selecting the RSI from among a plurality of predefined RSIs based on the account type.

6. The system of claim 1, wherein the query to the billing system and the determination of the RSI are performed before establishing a user plane data session for the UE.

7. The system of claim 1, wherein the authorization success message includes an indication of the determined RSI embedded in an authorization accept procedure.

8. The system of claim 1, wherein the attach procedure is completed based at least in part on the determined RSI prior to initiating a charging session for the UE.

9. A non-transitory computer readable media having computer-executable instructions stored thereon that, when executed by one or more computer processor components, cause the one or more computer processor components to perform operations for dynamic roaming authorization and policy provisioning in a communications network, the operations comprising:
receiving, from a visited public mobile network (VPMN), an attach request associated with a user equipment (UE);during an authorization procedure associated with the attach request, initiating, via a billing query module, a query to a billing system to retrieve an account type associated with the UE;receiving, from the billing system, a response indicating the account type associated with the UE;
determining, based at least in part on the retrieved account type, a roaming subscriber identity (RSI) for the UE; and
transmitting, toward the VPMN, an authorization success message that includes the determined RSI.

10. The media of claim 9, wherein the network component is further configured to dynamically modify the RSI associated with the UE in response to roaming across different VPMNs.

11. The media of claim 9, wherein the billing query module is configured to select between different RSIs based on a policy framework comprising roaming partner agreements.

12. The media of claim 9, further comprising determining, responsive to a failure to retrieve the account type from the billing system, a default RSI for the UE.

13. The media of claim 9, wherein the query to the billing system and the determination of the RSI are performed before establishing a user plane data session for the UE.

14. The media of claim 9, wherein the authorization success message includes an indication of the determined RSI embedded in an authorization accept procedure.

15. A method for dynamic roaming authorization and policy provisioning in a communications network, the method comprising:
receiving, from a visited public mobile network (VPMN), an attach request associated with a user equipment (UE);during an authorization procedure associated with the attach request, initiating, via a billing query module, a query to a billing system to retrieve an account type associated with the UE;receiving, from the billing system, a response indicating the account type associated with the UE;
determining, based at least in part on the retrieved account type, a roaming subscriber identity (RSI) for the UE; and
transmitting, toward the VPMN, an authorization success message that includes the determined RSI.

16. The method of claim 15, wherein the account type indicates one of a consumer account, a business account, or a government account, and wherein determining the RSI comprises selecting the RSI from among a plurality of predefined RSIs based on the account type.

17. The method of claim 15, wherein the query to the billing system and the determination of the RSI are performed before establishing a user plane data session for the UE.

18. The method of claim 15, wherein the authorization success message includes an indication of the determined RSI embedded in an authorization accept procedure.

19. The method of claim 15, wherein the billing query module is configured to select between different RSIs based on a policy framework comprising roaming partner agreements.

20. The method of claim 15, further comprising determining, responsive to a failure to retrieve the account type from the billing system, a default RSI for the UE.
